(19) United States
(12) Patent Application Publication
(10) Pub. No.: US 2025/0105514 A1
(43) Pub. Date: Mar. 27, 2025

(54) HALF-WAVELENGTH ANTENNA DEVICE AND LOW-PROFILE ANTENNA DEVICE USING SAME

(71) Applicant: HARADA INDUSTRY CO., LTD., Tokyo (JP)

(72) Inventor: Shinji IINO, Shinagawa-ku, Tokyo (JP)

(21) Appl. No.: 18/709,435

(22) PCT Filed: Nov. 9, 2022
(86) PCT No.: PCT/JP2022/041638

§ 371 Date: Dec. 5, 2024

(30) Foreign Application Priority Data
Nov. 16, 2021 (JP) 2021-186311

(51) Int. Cl. H01Q 5/378; H01Q 9/32; H01Q 9/40; H01Q 19/26; H01Q 21/30

(52) U.S. Cl. CPC H01Q 5/378; H01Q 9/32; H01Q 9/40; H01Q 19/26; H01Q 21/30

(57) ABSTRACT

To provide a small-sized half-wavelength antenna device capable of adjusting directivity. A half-wavelength antenna device for a vehicle includes: a conductive plate 10; a half-wavelength element 20; and a parasitic element 30. The conductive plate 10 has a feeding part 11 and a ground 12. The half-wavelength element 20 is vertically installed on the conductive plate 10 so as to be connected to the feeding part 11 but insulated from the ground 12. The parasitic element 30 is disposed in proximity and parallel to the half-wavelength element 20 so as to be electromagnetically coupled thereto but insulated from the ground 12.

### TECHNICAL FIELD

The present invention relates to a half-wavelength antenna device and a low-profile antenna device using the same, and more particularly to a half-wavelength antenna device capable of adjusting directivity and a low-profile antenna device using the half-wavelength antenna device.

### BACKGROUND ART

Various types of antenna devices are available for vehicles these days. One example is an AM/FM radio antenna for receiving AM and FM broadcasts. A rod antenna is typically used as the AM/FM radio antenna. The rod antenna includes an element part in which an element (helical element) constituted by a helical conductor is covered with a cover member and a base plate for mounting the element part.

When the rod antenna is mounted onto a vehicle body, the element part significantly protrudes from the vehicle body. This may spoil the beauty and design of the vehicle and cause breakage during garaging or car washing. Further, the rod antenna is exposed from the vehicle body, so that the element part has a possibility of being stolen.

To cope with such problems, there is proposed a low-profile antenna device designed so as to make the entire device height lower than the height of the rod antenna, to accommodate the element in an antenna case to prevent exposure thereof to the outside, and to form the antenna case into a FUKAHIRE shape (a shark fin shape) considering the design property of the entire vehicle mounted with the antenna device. Such a low-profile antenna device often has a height of 70 mm or less and a length in the longitudinal direction of about 200 mm in consideration of regulations.

However, the low-profile antenna device having a height as low as 70 mm or less may degrade radiation efficiency due to antenna conductor loss (reduction in element length), which may cause sensitivity degradation. Further, recently, various types of antennas, such as a TEL antenna, a GPS antenna, and a V2X antenna for vehicle-vehicle/road-vehicle communication need to be mounted on the vehicle as a composite antenna device. Under such circumstance, it must be solved how to accommodate a plurality of such antennas in the narrow space of the low-profile antenna device. Further, when the plurality of antennas are accommodated in the narrow space, antenna directivity needs to be adjusted depending on a combination of the antennas.

For example, Patent Document 1 discloses an antenna device that adjusts the directivity of a patch antenna having a patch element with a curved or bent surface. Specifically, the device disclosed in Patent Document 1 adjusts directivity in a zenithal direction with a curved or bent surface shaped patch element.

Patent Document 2 discloses an antenna device that adjusts the directivity of an antenna element. Specifically, in the device disclosed in Patent Document 2, a ground and a parasitic element are disposed parallel to an antenna element functioning as a dipole or monopole antenna, and the parasitic element is used as a reflector, whereby the directivity is adjusted.

### CITATION LIST

### Patent Document

Patent Document 1: Japanese Patent Application Kokai Publication No. 2019-068124
Patent Document 2: International Publication No. WO 2018/198349

### DISCLOSURE OF THE INVENTION

### Problems to be Solved by the Invention

However, the device disclosed in Patent Document 1 aims to adjust the directivity of a patch antenna, not to adjust the directivity of a linearly polarized antenna. Further, the device disclosed in Patent Document 2 aims to adjust the directivity of a ¼-wavelength planar antenna element.

A composite antenna accommodating a plurality of antennas can use another antenna as a reflector or a radiator. In this case, the antennas need to be disposed spaced apart from one another by ¼ wavelength. However, it is difficult to ensure the distance between the antennas in a narrow space of the low-profile antenna device.

The present invention has been made in view of the above situation, and an object thereof is to provide a small-sized half-wavelength antenna device capable of adjusting directivity. Another object of the present invention is to provide a low-profile antenna device using such a half-wavelength antenna device.

### Means for Solving the Problems

To achieve the above object of the present invention, a half-wavelength antenna device according to the present invention includes: a conductive plate having a feeding part and a ground; a half-wavelength element vertically installed on the conductive plate, the half-wavelength element being connected to the feeding part but insulated from the ground; and a parasitic element disposed in proximity and parallel to the half-wavelength element so as to be electromagnetically coupled thereto but insulated from the ground.

The half-wavelength element may be constituted by a planar element and may have a slit formed on both sides of a feeding line to the feeding part so as to achieve impedance matching.

The half-wavelength antenna device may further include a dielectric substrate, and the half-wavelength element and the parasitic element may be respectively disposed on front and back surfaces of the dielectric substrate.

A low-profile antenna device for a vehicle using the half-wavelength antenna device according to the present invention may include: a base plate fixed to the vehicle; an element for a first frequency band disposed spaced apart from the base plate in a height direction of the vehicle and configured to function as an antenna for the first frequency band; and an antenna cover fitted to the base plate and accommodating thereinside the element for the first frequency band. At least the half-wavelength element and the parasitic element of the half-wavelength antenna device may be disposed so as to be covered with the element for the first frequency band as viewed from above.

The low-profile antenna device may further include: a circuit board disposed on the base plate and having a feeding terminal; and a coil connected between the element for the first frequency band and the feeding terminal and adjusted to function as a resonance antenna for a second frequency band by a series circuit of the element for the first frequency band and the coil. The coil may be disposed such that an axial direction thereof is parallel to the base plate and is parallel to a longitudinal direction of the element for the first frequency band.

### Advantageous Effects of the Invention

The half-wavelength antenna device according to the present invention and the low-profile antenna device using the same are advantageous in that they are small-sized and capable of adjusting directivity.

### BRIEF DESCRIPTION OF THE DRAWINGS

FIG. 1 is a schematic side view for explaining a half-wavelength antenna device according to the present invention;

FIG. 2 is a schematic perspective view for explaining a specific example of the half-wavelength antenna device according to the present invention;

FIG. 3 is a directivity pattern exhibited by the half-wavelength antenna device according to the present invention;

FIG. 4 illustrates, as a comparative example, a directivity pattern when the parasitic element is connected to the ground;

FIG. 5 is a schematic perspective view for explaining another specific example of the half-wavelength antenna device according to the present invention;

FIG. 6 is a schematic view for explaining a still another specific example of the half-wavelength antenna device according to the present invention; and

FIG. 7 is a schematic side view for explaining a low-profile antenna device using the half-wavelength antenna device according to the present invention.

### BEST MODE FOR CARRYING OUT THE INVENTION

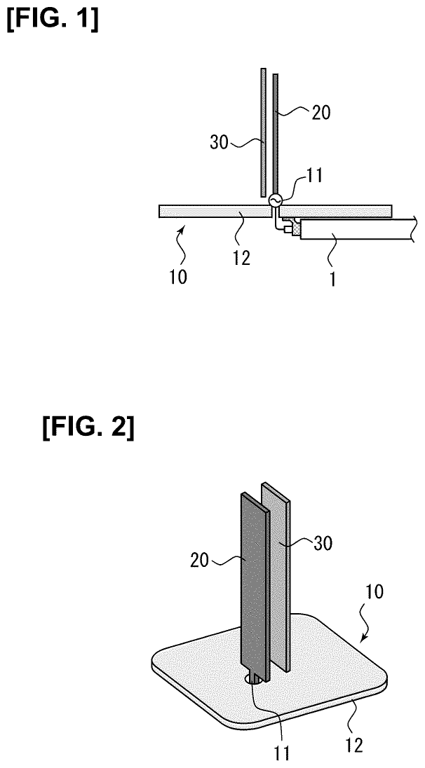

Hereinafter, am embodiment for practicing the present invention will be described with illustrated examples. FIG. 1 is a schematic side view for explaining a half-wavelength antenna device according to the present invention. As illustrated, the half-wavelength antenna device according to the present invention includes a conductive plate 10, a half-wavelength element 20, and a parasitic element 30. It is fed with power through a coaxial cable 1.

The conductive plate 10 has a feeding part 11 and a ground 12. The conductive plate 10 may be provided by a printed board. That is, the solid ground part of the printed board serves as the ground 12, and a part insulated from the ground 12 serves as the feeding part 11. The internal conductor of the coaxial cable 1 may be connected to the feeding part 11, and the external conductor thereof may be connected to the ground 12. The conductive plate 10 need not necessarily be a printed board but may be, for example, a member obtained by forming a through hole in a planar conductor for the feeding part 11.

The half-wavelength element 20 is vertically installed on the conductive plate 10. The half-wavelength element 20 is connected to the feeding part 11 but insulated from the ground 12. In the illustrated example, the half-wavelength element 20 is installed at right angles on the conductive plate 10; however, the present invention is not limited to this, but a slight inclination is allowed as long as the conductive plate 10 is disposed so as to serve as a ground board for the half-wavelength element 20. Further, in the illustrated example, the half-wavelength element 20 is a bar-like element; however, the present invention is not limited to this, but the half-wavelength element 20 may be a planar element.

The half-wavelength element 20 is a monopole antenna having an element length set to ½ of the wavelength of a corresponding frequency band. Specifically, when the half-wavelength element 20 is an element for V2X, for example, the element length may be ½ of the wavelength of 5.9 GHz band. The element length of the half-wavelength element 20 may be adjusted as needed depending on a wavelength reduction rate or the like.

The parasitic element 30 is disposed in proximity and parallel to the half-wavelength element 20 so as to be electromagnetically coupled thereto. The parasitic element 30 is insulated from the ground 12. That is, the parasitic element 30 is connected to neither the ground 12 nor the feeding part 11. The parasitic element 30 is preferably equivalent or larger in size than the half-wavelength element 20 so as to be electromagnetically coupled to the half-wavelength element 20 over a range as wide as possible. The half-wavelength antenna device according to the present invention can adjust antenna directivity depending on the position, length and width of the parasitic element 30 and a distance from the half-wavelength element 20. For example, the parasitic element 30 may be disposed in proximity and parallel to the half-wavelength element 20 at a distance of about, e.g., 1/20 wavelength therefrom. The parasitic element 30 may be disposed so as to be spaced upward from the ground 12 by, e.g., about 1 mm.

In the thus configured half-wavelength antenna device according to the present invention, the half-wavelength element 20 is vertically installed on the conductive plate 10 and thus acts like a monopole antenna, as well as like a microstrip antenna due to electromagnetic coupling of the parasitic element 30 to the half-wavelength element 20.

The half-wavelength antenna device according to the present invention can adjust directivity by using the parasitic element 30. Specifically, the directivity of the half-wavelength element 20 can be directed toward the side opposite to the side at which the parasitic element 30 is provided. That is, the parasitic element 30 acts like a reflector for the half-wavelength element 20. However, since the reflector needs to be disposed spaced apart from the half-wavelength element 20 by ¼ wavelength or more, the parasitic element 30 acts unlike the reflector.

As described above, the half-wavelength antenna device according to the present invention is configured such that the half-wavelength element 20 and the parasitic element 30 are disposed in proximity to each other, thereby reducing the entire size. Further, despite its small size, the directivity can be adjusted by using the parasitic element 30.

FIG. 2 is a schematic perspective view for explaining a specific example of the half-wavelength antenna device according to the present invention. In the drawings, the same reference numerals as those in FIG. 1 denote the same parts. In this example, the half-wavelength element 20 is constituted by a planar element. For example, the planar half-wavelength element 20 may be formed by cutting a sheet metal through sheet metal working. The parasitic element 30 is also constituted by a conductive planar body. As with the half-wavelength element 20, the parasitic element 30 may be formed by cutting a sheet metal through sheet metal working. With this configuration, the parasitic element 30 is electromagnetically coupled to the half-wavelength element 20 more strongly, so that the directivity can be adjusted over a wider range.

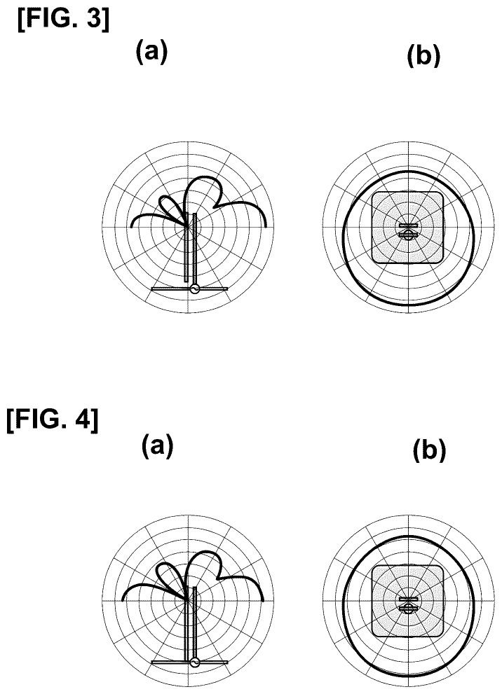

FIG. 3 is a directivity pattern exhibited by the half-wavelength antenna device according to the present invention. FIG. 3A illustrates directivity in the vertical direction, and FIG. 3B illustrates directivity in the horizontal direction. When the parasitic element is absent, the directivity pattern becomes omni-directional. As illustrated, the half-wavelength antenna device according to the present invention has directivity toward the side opposite to the side at which the parasitic element 30 is provided. As described above, the half-wavelength antenna device according to the present invention can adjust the directivity of the half-wavelength element 20 by using the parasitic element 30 disposed in proximity to the half-wavelength element 20.

When the parasitic element 30 is connected to the ground 12, the directivity as illustrated in FIG. 4 is exhibited. FIG. 4 illustrates, as a comparative example, a directivity pattern when the parasitic element is connected to the ground. FIG. 4A illustrates directivity in the vertical direction, and FIG. 4B illustrates directivity in the horizontal direction. As illustrated, when the parasitic element 30 is connected to the ground 12, the directivity pattern is brought closer to omni-directivity than in the case of the half-wavelength antenna device according to the present invention. Therefore, the parasitic element 30 is preferably not connected to but insulated from the ground 12. As described above, in the present invention, since there is no need to connect the parasitic element 30 to the ground 12, the degree of freedom in arrangement of the parasitic element 30 is high.

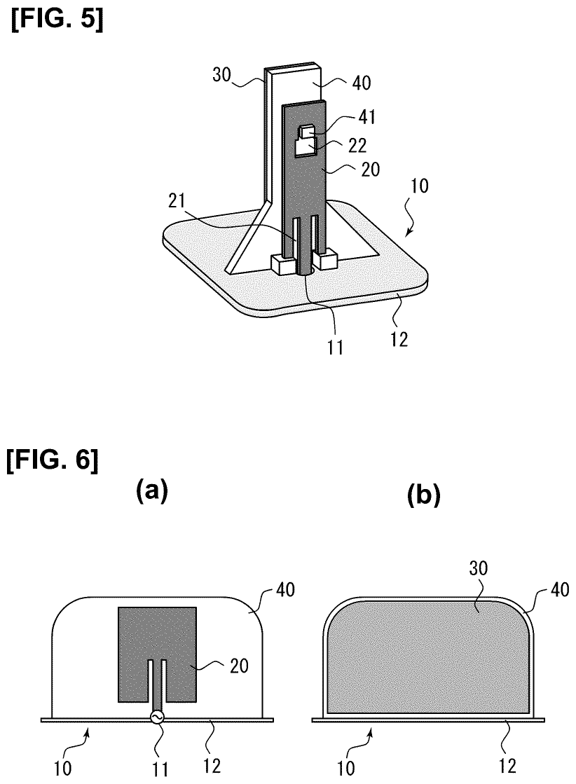

FIG. 5 is a schematic perspective view for explaining another specific example of the half-wavelength antenna device according to the present invention. In the drawings, the same reference numerals as those in FIG. 1 denote the same parts. As in the example illustrated in FIG. 2, the half-wavelength element 20 is constituted by a planar element. In this example, the half-wavelength element 20 has a slit 21 formed on both sides of a feeding line to the feeding part 11. The slit 21 is used for impedance matching. That is, adjusting the depth of the slit 21 can change the length of the feeding line without involving a change in the length of the planar element, thereby achieving impedance matching to, e.g., 50 02. Thus, forming the slit 21 eliminates the need of additionally providing a matching circuit, for example.

Further, in this example, a base 40 is disposed between the half-wavelength element 20 and the parasitic element 30. The base 40 may be made of an insulating body. The base 40 may be fixed to the conductive plate 10 so as to be vertically installed thereon, and the half-wavelength element 20 and the parasitic element 30 may be respectively disposed on the front and back sides of the base 40. A locking hole 22 is formed in each of the half-wavelength element 20 and the parasitic element 30, and a locking claw 41 to be locked to the locking hole 22 is formed in the base 40, thus facilitating assembly therebetween. Further, when the base 40 is made of a dielectric, the element length can be reduced, achieving further miniaturization.

FIG. 6 is a schematic view for explaining a still another specific example of the half-wavelength antenna device according to the present invention. FIG. 6A is a front side view, and FIG. 6B is a rear side view. In the drawings, the same reference numerals as those in FIG. 2 denote the same parts. As illustrated, the base 40 is constituted by a dielectric substrate, and the half-wavelength element 20 and the parasitic element 30 are respectively disposed on the front and back sides of the base 40. In this example, as the base 40, a double-side printed board having metal thin films on both sides thereof is prepared. The thin metal films of the double-sided printed board are patterned so as to serve respectively as the half-wavelength element 20 and the parasitic element 30 of the half-wavelength antenna device according to the present invention. Thus, the half-wavelength element 20 and the parasitic element 30 may be obtained not through sheet metal working but through pattern formation on the surfaces of the printed board.

The thus configured half-wavelength antenna device according to the present invention is capable of adjusting directivity despite its small size and is thus applicable to a low-profile antenna for a vehicle. That is, in the case where the half-wavelength antenna device according to the present invention needs to be applied to an antenna device having a narrow internal space like a shark fin shaped low-profile antenna having a height of 70 mm or less, it can be easily accommodated and can achieve desired directivity.

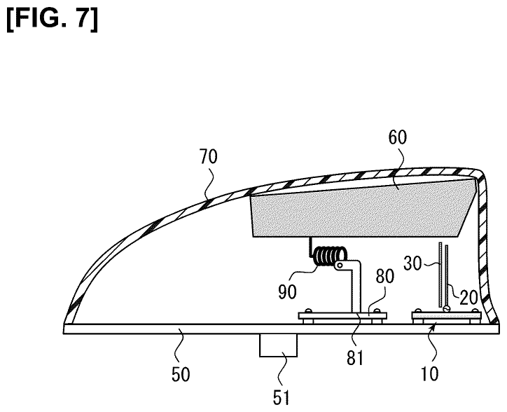

FIG. 7 is a schematic side view for explaining a low-profile antenna device using the half-wavelength antenna device according to the present invention. It partially exhibits a cross section for explaining the inside of the low-profile antenna device. As illustrated, the low-profile antenna device using the half-wavelength antenna device according to the present invention includes a base plate 50, an element 60 for the first frequency band, and an antenna cover 70.

The base plate 50 is fixed to the vehicle. Specifically, the base plate 50 may be a so-called resin base formed of an insulator such as resin, or may be a so-called metal base formed of a conductor such as metal. Also, the base plate 50 may be a composite base of resin and metal. For example, a screw boss 51 is provided on the base plate 50. The screw boss 51 is inserted into a hole formed in a roof or the like of the vehicle, and a nut is fastened from a vehicle cabin side to fix the base plate 50 to the roof so as to sandwich the roof between the nut and the base plate 50. A power supply cable or a coaxial cable for connecting the vehicle interior and the antenna device is inserted through the screw boss 51. Further, the base plate 50 is configured to be covered with an antenna cover 70, the detail of which will be described later.

The element 60 for the first frequency band functions as an antenna for a first frequency band. For example, the element 60 for the first frequency band may be a so-called capacity loaded element. Specifically, the first frequency band may be an AM frequency band. In the AM frequency band, the element 60 for the first frequency band functions as a capacitive antenna. The element 60 for the first frequency band may have an element length corresponding to a desired frequency band. In this case, the first frequency band may be, e.g., a DTV frequency band. In the DTV frequency band, the element 60 for the first frequency band functions as a resonance antenna. The element 60 for the first frequency band is disposed spaced apart from the base plate 50 in the height direction. In the example illustrated in FIG. 7, the left side is a vehicle traveling direction, and the longitudinal direction of the element 60 for the first frequency band faces the vehicle traveling direction.

The antenna cover 70 is fitted to the base plate 50 so as to accommodate thereinside the element 60 for the first frequency band. In the illustrated example, the antenna cover 70 defines the outer shape of the low-profile antenna device. However, the low-profile antenna device according to the present invention is not limited to this. For example, the antenna cover 70 may have an inner cover and an outer cover, i.e., a double cover structure. In this case, the inner cover accommodates thereinside the element 60 for the first frequency band, and the outer cover defines the outer shape.

The half-wavelength antenna device according to the present invention is disposed at a position covered with the element 60 for the first frequency band as viewed from above. Specifically, the conductive plate 10 is fixed to a boss provided on the base plate 50, and the half-wavelength element 20 and the parasitic element 30 are disposed below the element 60 for the first frequency band so as to be covered therewith. It is not essential that the conductive plate 10 is completely covered with the element 60 for the first frequency band, but it is sufficient that at least the half-wavelength element 20 and the parasitic element 30 are covered with the element 60 for the first frequency band. Further, the conductive plate 10 need not necessarily be provided separately from the base plate 50; when the base plate 50 is a metal base, the base plate 50 may be used as the conductive plate 10.

When an antenna element is disposed at the rear side of the low-profile antenna device in the vehicle traveling direction, forward radiation in the vehicle traveling direction is generally affected by the element 60 for the first frequency band or the like. However, in the half-wavelength antenna device according to the present invention, directivity can be adjusted, and it is adjusted so as to be directed rearward in the vehicle traveling direction. Specifically, the parasitic element 30 and the half-wavelength element 20 are respectively disposed at the front side and at the rear side in the vehicle traveling direction, whereby the directivity of the half-wavelength element 20 is directed rearward in the vehicle traveling direction. Further, the directivity can be corrected by adjusting the width and height of the parasitic element 30 or distance between the parasitic element 30 and the half-wavelength element 20 even under influence of a surrounding metal material or dielectric in the narrow space of the low-profile antenna. Therefore, the half-wavelength antenna device need not be disposed avoiding the element 60 for the first frequency band, thus increasing the degree of freedom in arrangement of the half-wavelength antenna device in the narrow space inside the antenna cover of the low-profile antenna device.

In the example of FIG. 7, the low-profile antenna device using the half-wavelength antenna device according to the present invention has a circuit board 80 and a coil 90. Thus, the low-profile antenna device can be designed as a composite antenna. The circuit board 80 is disposed on the base plate 50 and has a feeding terminal 81. The circuit board 80 has thereon an amplifier circuit and/or a filter circuit as needed and is configured to receive signals. The coil 90 is connected between the element 60 for the first frequency band and the feeding terminal 81. By a series circuit of the element 60 for the first frequency band and the coil 90, the function of a resonance antenna for a second frequency band is achieved. The second frequency band may be an FM frequency band. For example, the inductance of the coil 90 is appropriately selected so as to allow the series circuit of the element 60 for the first frequency band and the coil 90 to function as a resonance antenna in the FM frequency band.

As illustrated, the coil 90 is disposed such that the axial direction thereof is parallel to the base plate 50 and longitudinal direction of the element 60 for the first frequency band. The coil 90 is thus disposed laterally, so that even when the length (number of turns) of the coil 90 differs depending on the vehicle type, only the lateral length is changed, but the distance from the circuit board 80 stays the same. Thus, adjusting the length of the coil 90 has little influence on the antenna reception characteristics of the low-profile antenna device.

The half-wavelength antenna device according to the present invention is not limited to the above examples, but may be variously modified within the scope of the present invention.

### REFERENCE SIGNS LIST

1: Coaxial cable
10: Conductive plate
11: Feeding part
12: Ground
20: Half-wavelength element
21: Slit
22: Locking hole
30: Parasitic element
40: Base
41: Locking claw
50: Base plate
51: Boss
60: Element for the first frequency
70: Antenna cover
80: Circuit board
81: Feeding terminal
90: Coil

1. A half-wavelength antenna device for a vehicle comprising:
a conductive plate having a feeding part and a ground;
a half-wavelength element vertically installed on the conductive plate, the half-wavelength element being connected to the feeding part but insulated from the ground; and
a parasitic element disposed in proximity and parallel to the half-wavelength element so as to be electromagnetically coupled thereto but insulated from the ground.

2. The half-wavelength antenna device according to claim 1, in which the half-wavelength element is constituted by a planar element and has a slit formed on both sides of a feeding line to the feeding part so as to achieve impedance matching.

3. The half-wavelength antenna device according to claim 1 or claim 2, which further comprises a dielectric substrate, wherein the half-wavelength element and the parasitic element are respectively disposed on front and back surfaces of the dielectric substrate.

4. A low-profile antenna device for a vehicle using the half-wavelength antenna device according to any one of claims 1 to 3, which comprises:
a base plate fixed to the vehicle;
an element for a first frequency band disposed spaced apart from the base plate in a height direction of the vehicle and configured to function as an antenna for a first frequency band; and
an antenna cover fitted to the base plate and accommodating thereinside the element for the first frequency band, wherein
at least the half-wavelength element and the parasitic element of the half-wavelength antenna device are disposed so as to be covered with the element for the first frequency band as viewed from above.

5. The low-profile antenna device according to claim 4, which further comprises:
a circuit board disposed on the base plate and having a feeding terminal; and
a coil connected between the element for the first frequency band and the feeding terminal and adjusted to function as a resonance antenna for a second frequency band by a series circuit of the element for the first frequency band and the coil, wherein
the coil is disposed such that an axial direction thereof is parallel to the base plate and is parallel to a longitudinal direction of the element for the first frequency band.
